(19) United States
(12) Patent Application Publication
(10) Pub. No.: US 2005/0077713 A1
(43) Pub. Date: Apr. 14, 2005

(54) Hybrid inflator

(76) Inventors: Naoki Matsuda, Hyogo (JP); Nobuyuki Katsuda, Hyogo (JP)

Correspondence Address: BIRCH STEWART KOLASCH & BIRCH, PO BOX 747, FALLS CHURCH, VA, 22040-0747, US

(21) Appl. No.: 10/912,154

(22) Filed: Aug. 6, 2004

Related U.S. Application Data
(60) Provisional application No. 60/494,589, filed on Aug. 13, 2003.

(30) Foreign Application Priority Data
Aug. 11, 2003 (JP) 2003-291213

(51) Int. Cl. B60R 21/26

(52) U.S. Cl. 280/741

(57) ABSTRACT

The present invention provides a hybrid inflator in which the time up to the beginning of pressurized gas discharge during an operation is shortened. The present invention provides a hybrid inflator having an elongated inflator housing as an outer shell, wherein: a combustion chamber is provided on one end side of the inflator housing, a gas generating agent and an igniter for igniting the gas generating agent being accommodated inside the combustion chamber; a gas discharge port is provided on another end side of the inflator housing, a ventilation channel between the interior of the inflator housing and the gas discharge port being blocked by a rupturable plate; and the interior of the inflator housing is charged with a pressurized gas (preferably helium), a ratio (L/V) between a length L (m) of the inflator housing and a sound velocity V (ms⁻¹, 20° C.) of the pressurized gas being no more than 4.6×10⁻⁴ s.

### CROSS REFERENCE TO RELATED APPLICATIONS

This Nonprovisional application claims priority under 35 U.S.C. § 119(e) on U.S. Provisional Application No. 60/494,589 filed on Aug. 13, 2003 and under 35 U.S.C. § 119(a) on Patent Application No. 2003-291213 filed in Japan on Aug. 11, 2003; the entire contents of which are hereby incorporated by reference.

### BACKGROUND OF THE INVENTION

1. Field of the Invention

The present invention relates to a hybrid inflator which is suitable for use in an air bag system of an automobile.

2. Description of Related Art

When an inflator used in an air bag system installed in an automobile is of the type which inflates an air bag by discharging pressurized gas charged at high pressure, the rupturing of blocking means (a rupturable plate) which enable the pressurized gas to be discharged is of great importance.

In the case of side air bags and curtain air bags, a housing with an elongated form in the axial direction is preferable due to problems concerning installation space. Further, since the distance between a side structure of a vehicle body and a passenger in a vehicle cabin is smaller than that between the front side of the vehicle body and the passenger in the driving seat or front passenger seat, the expansion time of the air bag must be shortened, and hence it is important to reduce the time period from rupturing of the rupturable plate to discharge of the pressurized gas.

In JP 2003-81050 A, an elongated hybrid inflator is disclosed. A main body 2 and a reservoir 3 are disposed in series, the main body 2 containing two types of powder 13, 14 and an igniter 16 for igniting these powders 13, 14. An example of the pressurized gas is provided in Paragraph 9 as a mixture of helium, argon, nitrogen, and nitrous oxide.

In this hybrid inflator, activation of the igniter 16 causes the powder 14 to burn, whereby a rupturable plate blocking a communicating hole in the main body of the reservoir ruptures such that combustion gas is discharged into the reservoir 3, causing the pressure therein to rise. As a result of the impact wave caused when the combustion gas flows into the reservoir 3 and the increase in pressure, the rupturable plate provided on a channel 8 ruptures.

Since this hybrid inflator has an elongated form, the distance between the igniter 16 disposed at one end of the housing and the rupturable plate of the channel 8 is large, leading to an increase in the time required for the impact wave to reach the rupturable plate. To ensure that the passenger is protected, however, the air bag must be expanded as quickly as possible.

Among air bag systems, the distance between the passenger and the part of the vehicle structure in which the air bag system is installed is particularly small in the case of side air bags and curtain air bags, and it is therefore important in these cases to reduce the time period from activation of the igniter to discharge of the pressurized gas.

### SUMMARY OF THE INVENTION

An object of the present invention is to provide a hybrid inflator having an elongated form which is suitable for use as a side inflator or curtain inflator, in which the period up to the discharge of a pressurized gas can be shortened.

The present invention provides a hybrid inflator serving as means for achieving the object, having an elongated inflator housing as an outer shell, wherein
a combustion chamber is provided on one end side of the inflator housing, with a gas generating agent and an igniter for igniting and burning the gas generating agent being accommodated inside the combustion chamber,
a gas discharge port is provided on another end side of the inflator housing, a ventilation channel between the interior of the inflator housing and the gas discharge port being blocked by a rupturable plate, and
a pressurized gas charging space inside the inflator housing is charged with a pressurized gas, a ratio (L/V) between a length L (m) of the pressurized gas charging space and a sound velocity V (ms⁻¹, 20° C.) of the pressurized gas being no more than 4.6×10⁻⁴ s.

The elongated inflator housing refers to a housing having a well-known form (a long form in which the length is considerably greater than the diameter) such as that disclosed in FIG. 1 of JP 2003-81050 A.

When applied as an inflator for a side air bag or an inflator for a curtain air bag, the inflator housing preferably takes an elongated form due to restrictions on the attachment location on the side face of the vehicle body, and when the pressurized gas charging amount is increased, the length of the inflator housing must be increased even further.

When the inflator housing takes an elongated form in this manner, and is constituted with the rupturable plate and the combustion chamber at each end, the time period required for an impact wave produced by the high-temperature gas that is generated in the combustion chamber to reach the rupturable plate increases. However, by setting L/V at no more than 4.6×10⁻⁴ s, this time period can be maintained appropriately.

Hence, the present invention can respond to variation in the form of the inflator, variation in the form and volume of the air bag, and so on easily.

The present invention provides a hybrid inflator, comprising an elongated inflator housing constituting an outer shell,
a combustion chamber provided on a first end of the inflator housing for accommodating therein an igniter and a gas generating agent,
a gas discharge port provided on a second end of the inflator housing, directly opposite the first end, the gas discharge port having a ventilation channel between an interior of the inflator housing and the gas discharge port, said ventilation channel being blocked by a rupturable plate, and
a pressurized gas charging space inside the inflator housing charged with a pressurized gas, a ratio (L/V) between a length L (m) of the pressurized gas charging space and a sound velocity V (ms⁻¹, 20° C.) of the pressurized gas being no more than 4.6×10⁻⁴ s.

The present invention further provides a hybrid inflator, wherein the pressurized gas is helium.

Helium is a fast gas with a theoretical sound velocity value of 1010 ms⁻¹ (23° C.), and hence the propagation velocity of the impact wave produced when high-temperature gas is generated upon activation of the igniter is higher than that of other pressurized gases. As a result, the timing at which the rupturable plate blocking the gas discharge port ruptures can be advanced, enabling discharge of the pressurized gas to begin earlier.

The sound velocity (20° C.) of the pressurized gas used in the present invention is preferably at least 800 ms⁻¹, and more preferably 850 ms⁻¹, and helium is cited as a favorable pressurized gas. However, another gas may be mixed in with the helium provided that these numerical values are maintained.

The present invention provides a hybrid inflator, wherein the inflator housing is cylindrical, and the combustion chamber is disposed in series and concentrically with the inflator housing.

The present invention provides a hybrid inflator, wherein the igniter, the gas generating agent, the rupturable plate blocking the ventilation channel between the interior of the inflator housing and the gas discharge port, and the gas discharge port are co-linear.

When the various elements are co-linear in this manner, the pressure (impact wave) produced by combustion of the gas generating agent following activation of the igniter advances directly to reach the rupturable plate without attenuating. Thus, the force with which the rupturable plate is ruptured increases, enabling a reduction in the time required for discharge of the pressurized gas to begin.

The present invention provides a hybrid inflator, wherein a communicating hole is provided between the pressurized gas charging space in the interior of the inflator housing and the combustion chamber. In accordance with this invention, the communicating hole is blocked by the rupturable plate so that the pressure in the interior of the combustion chamber is ambient.

Since the communicating hole is blocked by the rupturable plate and the gas generating agent is accommodated in an ambient pressure atmosphere, pressure does not cause the gas generating agent to deteriorate. Hence the desired gas output can be realized, thus ensuring the reliability of the inflator. Note that the igniter and rupturable plate preferably face each other directly, and the rupturable plate is desirably collinear with the igniter, the gas generating agent, a rupturable plate, which blocks the ventilation channel between the interior of the inflator housing and the gas discharge port, and the gas discharge port.

The present invention provides a hybrid inflator, wherein the gas generating agent has a gas output of at least 1.2 mol/100 g.

By setting the gas output of the gas generating agent to a predetermined value or more, the pressure (impact wave) can be increased. As a result, the force with which the rupturable plate is ruptured increases, enabling a reduction in the time required for discharge of the pressurized gas to begin. Moreover, the proportion of combustion gas to the amount of gas required to expand the air bag can be increased, enabling a reduction in the pressurized gas charging amount, a corresponding reduction in the thickness of the inflator housing, and as a result, a reduction in the overall weight of the inflator.

Note that in the present invention, this effect (the shortening of the period from activation of the igniter to discharge of the pressurized gas) is achieved as the length of the pressurized gas charging space, i.e., the length of the inflator, becomes longer. Hence requests for alterations to the length of the inflator can be dealt with easily while maintaining good performance in terms of passenger safety.

The hybrid inflator of the present invention may be applied to various inflators used in an air bag system, but is particularly suited to an inflator for use in a side air bag or an inflator for use in a curtain air bag. However, the hybrid inflator of the present invention may also be applied as an inflator for use with a driver side air bag or front passenger side air bag.

The hybrid inflator of the present invention is capable of shortening the time required from activation of an igniter to discharge of a pressurized gas.

### BRIEF DESCRIPTION OF THE DRAWING

FIG. 1 is a conceptual diagram showing an axial cross section of a hybrid inflator.

### DETAILED DESCRIPTION OF THE PRESENT INVENTION

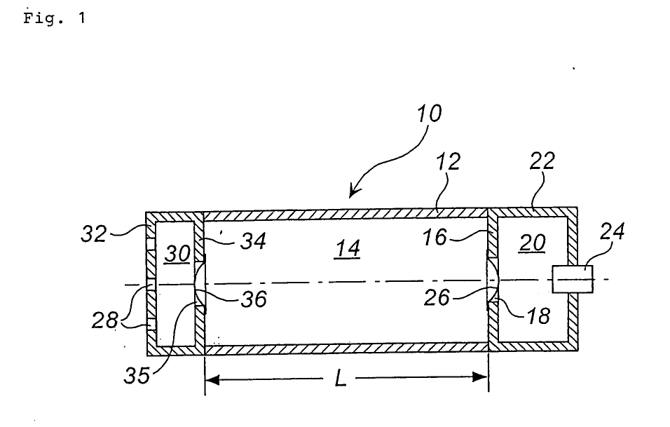

A hybrid inflator of the present invention will be described using FIG. 1. FIG. 1 is an axial sectional view showing a hybrid inflator. Note that FIG. 1 is a conceptual diagram for describing the present invention, and has been subjected to overall simplification. And, a constitutional element of a known hybrid inflator may be used as each of the constitutional elements.

A hybrid inflator 10 comprises an elongated inflator housing 12 as an outer shell.

The interior of the inflator housing 12 forms a pressurized gas charging space 14 into which an inert gas such as helium or argon, or a pressurized gas such as nitrogen gas, is charged. Note, however, that helium alone is preferable. The charging pressure of the pressurized gas differs according to the amount of gas generated from a gas generating agent, but is preferably between approximately 10 and 66 MPa.

The inflator housing 12 preferably has a circular cross section in the width direction, but does not necessarily have to be a perfect circle. Instead, the inflator housing 12 may be modified appropriately in accordance with the shape and so on of the space which serves as an attachment portion for the inflator 10 to take an elliptical form or a polygonal form which is close to a perfect circle.

A combustion chamber 20 is provided on one end side of the inflator housing 12. An outer shell of the combustion chamber 20 is formed by a combustion chamber housing 22 provided separately, and a gas generating agent (not shown) and an igniter 24 for igniting the gas generating agent are accommodated inside the combustion chamber 20. Note that rather than providing the combustion chamber housing 22 separately, a combustion chamber may be formed by partitioning the end portion of the inflator housing 12 or disposing the combustion chamber housing 22 inside the end portion of the inflator housing 12.

The combustion chamber 20 is disposed in series and concentrically with the inflator housing 12. A first dividing wall 16 having a first communicating hole 18 is provided between the pressurized gas charging space 14 and the combustion chamber 20, and the first communicating hole 18 is blocked by a disk-form first rupturable plate 26. (Note, however, that the drawing shows a state in which the first rupturable plate 26 is deformed into a bowl shape by the pressure of the pressurized gas). As a result, the pressurized gas in the pressurized gas charging space 14 does not flow into the combustion chamber 20, enabling the interior of the combustion chamber 20 to remain at ambient pressure inside the combustion chamber 20 so that pressure does not cause the gas generating agent to deteriorate.

There are no particular limitations on the charging amount, form, composition, and so on of the gas generating agent, but the gas output is preferably at least 1.2 mol/100 g, and more preferably at least 1.4 mol/100 g. The gas generating agent described in the embodiments and so on of JP 11-20598 A, for example, may be used as this gas generating agent.

Any component which comprises a required number of gas discharge ports 28 may be provided on the other end side of the inflator housing 12, for example, a diffuser portion 30 comprising the gas discharge ports 28 may be provided.

The outer shell of the diffuser portion 30 is formed by a diffuser housing 32, and the diffuser portion 30 is partitioned from the pressurized gas charging space 14 by a second dividing wall 34 having a second communicating hole 35. The second communicating hole 35 is blocked by a second rupturable plate 36. Note that the diffuser portion may be formed by partitioning the end portion of the inflator housing 12 rather than providing the diffuser housing 32 separately.

A filter formed from wire mesh or the like may be disposed on the diffuser portion 30 to prevent fragments of the second rupturable plate 36 and first rupturable plate 26 from escaping outside through the gas discharge ports 28.

In the hybrid inflator 10, the igniter 24, the gas generating agent accommodating space, the first rupturable plate 26 blocking the first communicating hole 18, the second rupturable plate 36 blocking the second communicating hole 35, and the gas discharge port 28 areco-linear.

In the hybrid inflator 10, a ratio (L/V) between a length L (m) of the pressurized gas charging space 14 and a sound velocity V (ms⁻¹, 20° C.) of the pressurized gas (helium) is no more than 4.6×10⁻⁴ s, preferably no more than 2.3×10⁻⁴ s, and more preferably no more than 2.0×10⁻⁴ s.

Next, an operation of the hybrid inflator 10 of the present invention when incorporated into an air bag system of an automobile will be described.

When the automobile collides with an object, the igniter 24 is activated to ignite the gas generating agent charged inside the combustion chamber 20. As a result, a flame and high-temperature combustion gas are generated, causing the first rupturable plate 26 directly facing the igniter 24 to rupture.

When the first rupturable plate 26 ruptures, the first communicating hole 18 opens, and hence the combustion gas flows into the pressurized gas charging space 14 to raise the pressure therein. At this time, the pressure (impact wave) advances directly to reach the second rupturable plate 36, thereby causing the second rupturable plate 36 to rupture.

When the second rupturable plate 36 ruptures, the second communicating hole 35 opens, causing the pressurized gas and combustion gas to flow into the diffuser portion 30 and escape from the gas discharge ports 28, as a result of which the air bag is inflated.

In the hybrid inflator 10, the igniter 24, the gas generating agent accommodating space, the first rupturable plate 26 blocking the first communicating hole 18, the second rupturable plate 36 blocking the second communicating hole 35, and the gas discharge port 28 are co-linear, and hence during such an operation, the impact wave advances directly without attenuating. Thus the first rupturable plate 26 and second rupturable plate 36 are ruptured with ease and with certainty.

Moreover, since helium, which has a high sound velocity, is charged as the pressurized gas, the propagation time of the impact wave is shortened, and hence the period from activation of the igniter 24 to discharge of the pressurized gas and combustion gas from the gas discharge port 28 is reduced.

Further, by using a gas generating agent with a gas output of at least 1.2 mol/100 g, the time required for rupturing the first rupturable plate 26 and second rupturable plate 36 is reduced. Note that since the gas generating agent is accommodated within an ambient pressure atmosphere and is not subjected to deterioration caused by pressure, the desired gas output is maintained.

For example, when L in FIG. 1 is 400 mm (0.4 m) and the temperature is 23° C., the period from activation of the igniter to discharge of the pressurized gas from the gas discharge port, or in other words the time required for the impact wave to pass along the length L, differs by approximately 0.80 msec when helium (sound velocity 1100 m/sec) is used and when argon (sound velocity 332 m/sec) is used (this period being approximately 0.40 msec when helium is used and approximately 1.20 msec when argon is used). This time difference increases as the value of L increases, and hence greatly affects the air bag expansion time when applied to an elongated inflator for use with a side air bag or curtain air bag.

1. A hybrid inflator having an elongated inflator housing as an outer shell, wherein
a combustion chamber is provided on one end side of the inflator housing, a gas generating agent and an igniter for igniting the gas generating agent being accommodated inside the combustion chamber,
a gas discharge port is provided on another end side of the inflator housing, with a ventilation channel between the interior of the inflator housing and the gas discharge port being blocked by a rupturable plate, and
a pressurized gas charging space inside the inflator housing is charged with a pressurized gas, a ratio (L/V) between a length L (m) of the pressurized gas charging space and a sound velocity V (ms⁻¹, 20° C.) of the pressurized gas being no more than 4.6×10⁻⁴ s.

2. A hybrid inflator, comprising:
an elongated inflator housing constituting an outer shell,
a combustion chamber provided on a first end of the inflator housing for accommodating therein an igniter and a gas generating agent,
a gas discharge port provided on a second end of the inflator housing, directly opposite the first end, the gas discharge port having a ventilation channel between an interior of the inflator housing and the gas discharge port, said ventilation channel being blocked by a rupturable plate, and
a pressurized gas charging space inside the inflator housing charged with a pressurized gas, a ratio (L/V) between a length L (m) of the pressurized gas charging space and a sound velocity V (ms⁻¹, 20° C.) of the pressurized gas being no more than 4.6×10⁻⁴ s.

3. A hybrid inflator according to claim 1 or 2, wherein the pressurized gas is helium.

4. A hybrid inflator according to claim 1 or 2, wherein the inflator housing is cylindrical, and wherein the combustion chamber is disposed in series and concentrically with the inflator housing.

5. A hybrid inflator according to claim 1 or 2, wherein the igniter, the gas generating agent, the rupturable plate, and the gas discharge port are co-linear.

6. A hybrid inflator according to claim 1 or 2, wherein a communicating hole is provided between the pressurized gas charging space in the interior of the inflator housing and the combustion chamber, and wherein the communicating hole is blocked by the rupturable plate so that the pressure in the interior of the combustion chamber is ambient.

7. A hybrid inflator according to claim 1 or 2, wherein the gas generating agent has a gas output of at least 1.2 mol/100 g.
